(19) United States
(12) Patent Application Publication
(10) Pub. No.: US 2025/0045707 A1
(43) Pub. Date: Feb. 6, 2025

(54) DEVICE AND METHOD FOR IDENTIFYING VEHICLE PART USABLE FOR USED PART RELATED SERVICE

(71) Applicants: Hyundai Motor Company, Seoul (KR); Kia Corporation, Seoul (KR); EFICAR Inc., Seongnam-si (KR)

(72) Inventor: Sang Gyun Park, Suwon-si (KR)

(21) Appl. No.: 18/523,392

(22) Filed: Nov. 29, 2023

(30) Foreign Application Priority Data
Jul. 31, 2023 (KR) 10-2023-0099817

(51) Int. Cl. G06Q 10/20; G06T 7/00; G06T 7/70

(52) U.S. Cl. CPC G06Q 10/20; G06T 7/0004; G06T 7/70; G06T 2207/10024; G06T 2207/20084; G06T 2207/20132; G06T 2207/30252

(57) ABSTRACT

A device for identifying a part of a vehicle is introduced. A device may comprise a processor, memory storing instructions, when executed by the processor, cause the device to receive a first image, pre-process the first image to output a second image, provide the second image to a neural network model that extracts features from the second image, and outputs, based on the extracted features, information associated with a recognized part of a vehicle, store the information associated with the recognized part of the vehicle as vehicle part information, and cause, based on the vehicle part information, a delivery of the recognized part of the vehicle.

### CROSS-REFERENCE TO RELATED APPLICATION

This application claims priority to and the benefit of Korean Patent Application No. 10-2023-0099817 filed in the Korean Intellectual Property Office on Jul. 31, 2023, the entire contents of which are incorporated herein by reference.

### TECHNICAL FIELD

The present disclosure relates to a device and a method of identifying parts of a vehicle, and more particularly, to a device and a method of identifying parts of a vehicle that are usable for a used part related service.

### BACKGROUND

If a vehicle needs to be repaired, used parts may be available. Used parts are traded as they are and may be priced based on the type of part, the unit of the part, and the like. Since pricing may be done through human visual identification, parts may be categorized into different names, types, and the like depending on people. Also, when used parts are traded, the part unit may not be accurately priced. For example, if a front bumper part is traded, there May be cases where the front bumper parts are priced the same for both the case where a grille is mounted inside the front bumper part and the case where a grille is not mounted inside the front bumper part. In this case, if the accurate part unit is priced, the front bumper mounted with the grille may be priced higher than the front bumper not mounted with the grille. As such, methods for objectively categorizing used parts and pricing accurate part units are desirable.

### SUMMARY

According to the present disclosure, a device may comprise a processor, memory storing instructions, when executed by the processor, cause the device to receive a first image, pre-process the first image to output a second image, provide the second image to a neural network model that extracts features from the second image, and outputs, based on the extracted features, information associated with a recognized part of a vehicle, store the information associated with the recognized part of the vehicle as vehicle part information, and cause, based on the vehicle part information, a delivery of the recognized part of the vehicle.

The device, wherein the instructions, when executed by the processor, cause the device to recognize a position of the recognized part in the first image, and crop, based on the position of the recognized part, the first image to include an entirety of the recognized part. The device, wherein the instructions, when executed by the processor, cause the device to crop by adjusting dimensions of the first image so that a ration of a width of the first image to a height of the first image is of 4 to 3.

The device, wherein the instructions, when executed by the processor, cause the device to change a pixel value of the first image to a new value. The device, wherein the instructions, when executed by the processor, cause the device to change the first image to have three color channels or one color channel. The device, wherein the instructions, when executed by the processor, cause the device to change an array of the first image based on a form of input associated with the neural network model.

The device, wherein the instructions, when executed by the processor, cause the device to determine, based on the neural network model, a number of vehicle parts in the second image, and determine, based on the number of vehicle parts, types of the vehicle parts. The device, wherein the instructions, when executed by the processor, cause the device to determine at least one of a compatible vehicle model of the recognized part or a color of the recognized part. The device, wherein the neural network model comprises a U-net model.

The device, wherein the instructions, when executed by the processor, cause the device to receive accident data associated with an occurrence of an accident as an input to the neural network model, based on the accident data, accessing the vehicle part information to search for a vehicle part associated with the accident data, and providing information associated with the vehicle part from the vehicle part information to a user.

According to the present disclosure, a method may comprise receiving, by a processor, a first image, pre-processing the first image to output a second image, providing the second image to a neural network model that extracts features from the second image, and outputs, based on the extracted features, information associated with a recognized part of a vehicle, storing the information associated with the recognized part of the vehicle as vehicle part information, and causing, based on the vehicle part information, a delivery of the recognized part of the vehicle.

The method, wherein the pre-processing comprises recognizing a position of the recognized part in the first image, and cropping, based on the position of the recognized part, the first image to include an entirety of the recognized part. The method, wherein the pre-processing comprises cropping by adjusting dimensions of the first image so that a ration of a width of the first image to a height of the first image are in is 4 to 3. The method, wherein the pre-processing comprises changing a pixel value of the first image to a new value.

The method, wherein the pre-processing comprises changing the first image to have three color channels or one color channel. The method, wherein the pre-processing comprises changing an array of the first image based on a form of input associated with the neural network model. The method, wherein the providing comprises determining, based on the neural network model, a number of vehicle parts in the second image, and determining, based on the number of vehicle parts, types of the vehicle parts.

The method, wherein the providing comprises determining at least one of a compatible vehicle model of the recognized part or a color of the recognized part. The method, wherein the neural network model comprises a U-net model. The method, further may comprise receiving accident data associated with an occurrence of an accident as an input to the neural network model, based on the accident data, accessing the vehicle part information to search for a vehicle part associated with the accident data, and providing information associated with the vehicle part from the vehicle part information to a user.

### BRIEF DESCRIPTION OF THE DRAWINGS

FIG. 1 shows an example of a vehicle part identifying device according to an example.

FIG. 2 shows an example of a vehicle part identifying method according to an example.

FIGS. 3 and 4 show examples of an operation of the vehicle part identifying device according to the example.

FIG. 5 shows an example of a vehicle part identifying device according to an example.

FIG. 6 shows an example of a vehicle part identifying method according to an example.

FIG. 7 shows an example of a computing device according to an example.

### DETAILED DESCRIPTION

The present disclosure will be described more fully hereinafter with reference to the accompanying drawings, in which examples of the disclosure are shown. As those skilled in the art would realize, the described examples may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification and the claims, unless explicitly described to the contrary, the word “comprise”, and variations such as “comprises” or “comprising”, will be understood to imply the inclusion of stated elements but not the exclusion of any other elements. Terms including an ordinary number, such as first and second, are used for describing various constituent elements, but the constituent elements are not limited by the terms. The terms are used only to discriminate one constituent element from another constituent element.

Terms such as “part,” “unit,” “module,” and the like in the specification may refer to a unit capable of performing at least one function or operation described herein, which may be implemented in hardware or circuitry, software, or a combination of hardware or circuitry and software.

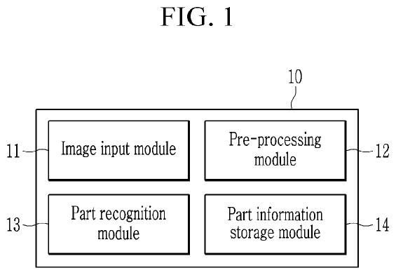

FIG. 1 shows an example of a vehicle part identifying device according to an example.

Referring to FIG. 1, a vehicle part identifying device 10 according to an example may include an image input module 11, a pre-processing module 12, a part recognition module 13, and a part information storage module 14. The vehicle part identifying device 10 may be used to identify used parts of a vehicle or in connection with services related to used parts of a vehicle without limitation. In this context, an element referred to herein as a “part” may refer to a used part of a vehicle. It is a matter of course that elements represented as “parts” herein are not limited to used parts of a vehicle.

As used herein, the term “vehicle” primarily refers to a means of transportation, such as a car, truck, bus, or motorcycle, but the scope is not limited thereto and includes any means of transportation or mobility that provides mobility for people or objects.

The image input module 11 may receive an input of a first image. The first image may be a captured image of a part of a vehicle. The first image may include an image input or uploaded to the image input module 11 by a user of the vehicle part identifying device 10. For example, the first image may has JPEG format, PNG format, or BMP format, and may be at least 256 pixels by 256 pixels in size. The image input module 11 may not perform any additional processing on the first image provided by the user. In some examples, the user may be a used part supplier. In this case, the vehicle part identifying device 10 may implement an upload interface to allow a used part supplier to connect and upload the first image.

The pre-processing module 12 may pre-process the first image to output a second image. The second image may be an image that has been pre-processed as described above for the first image prior to input into a neural network model that performs vehicle part recognition.

The pre-processing module 12 may recognize a position of the part in the first image and crop the first image to include the entire part based on the recognized position of the part. For example, the pre-processing module 12 may recognize the position of the part in the first image, and crop the first image to include the entire part based on the recognized position of the part, but with a predetermined ratio of width to height, to remove areas that are unnecessary for recognizing the vehicle part. Accordingly, it is possible to reduce the size of the images processed and the amount of computation required to process the image. In some examples, the pre-processing module 12 may crop the first image at a ratio of 4:3.

Further, the pre-processing module 12 may perform image normalization on the first image. Image normalization may be used to speed up the training of the neural network model that performs the vehicle part recognition, stabilize the optimization process, and improve overall learning performance. Specifically, the pre-processing module 12 may perform image normalization by adjusting pixel values of the first image. For example, the pixel values in the first image are represented as integers between 0 and 255, and these values may be normalized to change to a first value or a second value. In some examples, the first value may be 0 and the second value may be 1. Following this processing, the first image can be transformed into a second image that is more suitable for processing by a neural network model that performs vehicle part recognition. In some examples, the pre-processing module 12 may use an arithmetic-based Z-score normalization method, such as a method of dividing all or some pixel values by 255, or subtracting the mean from the pixel values and dividing a result value of the subtraction by the standard deviation, to scale the pixel values between 0 and 255 in the first image to a range of 0 and 1.

Further, the pre-processing module 12 may adjust channels of the first image. Specifically, the pre-processing module 12 may adjust the channels of the first image to three channels or one channel. The first image may include three color channels, typically RGB (Red, Green, Blue), each of which may include values representing the corresponding color intensity of a pixel. Depending on the neural network model performing the vehicle part recognition, it may reorder the channels, and depending on the framework, it may use RBG or BGR ordering rather than RGB ordering. The pre-processing module 12 may perform a channel swap to change the order of the three color channels as described above. On the other hand, depending on a neural network model performing vehicle part recognition, a grayscale image of a single channel may be used to process a black and white image. In such cases, the pre-processing module 12 may reduce the three color channels to one color channel.

Further, the pre-processing module 12 may change an array of the first image according to the form of input supported by the neural network model performing the vehicle part recognition. By changing the image into an array form, the pre-processing module 12 may make the image be suitable for numerical processing in the neural network model. If desirable, the pre-processing module 12 may change an image of a specific array form to another array form. For example, if the neural network model uses a one-dimensional array, the pre-processing module 12 may also change an image of a three-dimensional array to a one-dimensional array.

The part recognition module 13 may perform vehicle part recognition by providing the second image obtained through the pre-processing module 12 to the neural network model that performs the vehicle part recognition. Here, the neural network model may be a neural network model that performs encoding, which extracts features from the input image, and decoding to output a result of the recognition of the vehicle part in the input image by using the extracted features.

In some examples, the neural network model may include a U-net model. U-net is a convolutional neural network architecture, where the structure of the network is shaped like a “U”. The structure of the network may include an encoder, which downsamples the image, and a decoder, which upsamples the image. Sometimes, the encoder is referred to as a contracting path and the decoder is referred as an expansive path. The down-sampling path includes a convolutional layer and a max pooling layer, and the number of feature maps increases by a factor of two at each operation, and the up-sampling path includes a convolutional layer and a transposed convolutional layer, and the number of feature maps decreases by a factor of half at each operation, and the image may be restored to its original resolution. In particular, in the U-net model, there is a skip connection between the encoder and decoder, where the output of the down-sampling path is connected to the input of the up-sampling path at the same stage, allowing the net to preserve the high-resolution detail information of the input image. Further, the U-net model is also useful for segmentation tasks with relatively little data, which may be used to generate segmentation maps for recognizing vehicle parts from input images.

The part recognition module 13 may obtain the number of parts in the second image by using the neural network model described above, and may obtain types of parts as much as the number of parts. For example, the part recognition module 13 may obtain that the number of parts in the second image is two, and obtain that the two parts are a front bumper and a grille. Alternatively, the part recognition module 13 may obtain that the number of parts in the second image is two, and obtain that the two parts are a door and a door trim. Further, the part recognition module 13 may further obtain at least one of a compatible vehicle model of the part and a color of the part. For example, the part recognition module 13 may calculate available vehicle models by comparing the image with images of predetermined labels, and may calculate the color of the part by recognizing the color of the part for several predetermined colors.

The part information storage module 14 may store a result of the part recognition by the part recognition module 13 as part information. Specifically, the part information storage module 14 may store the number of parts in the image, information about the type of part, information about the unit of the part, and the like as part information.

The existing used part selling system was to visually identify the part name, type, part unit, and the like of the used part and upload the identified part name, type, part unit, and the like of the used part manually by an inspector. This method relies on the operator's judgment to determine the part name, type, and the like, resulting in many errors in data recording and the use of different names and classifications. In addition, part units are often mispriced, which may result in market sales at prices that are not in line with the value of the part. For example, if a front bumper of BMW 520d is priced at KRW 15.2 million, there may be a case where a front bumper with a grille is priced as a single front bumper and sold for KRW 15.2 million due to mispricing of a part unit. If the part unit had been properly priced, the value creation would have been worth the price of the grill. On the other hand, if a vehicle in need of repair only needs a front bumper, but due to a unit mispricing, a front bumper with a grille is shipped, the grille will be discarded, resulting in a waste of resources.

According to the example, in accordance with the configurations as described above, accurate part identification may be achieved through image analysis to provide objective and automated part identification for use in used part-related services. Accordingly, it is possible to reduce the risk of exchanges and returns due to mislabeled parts, ensure that used parts are properly priced according to their value, and reduce scrap disposal costs. In addition, the supply of used parts to the market may be further stimulated by used parts companies receiving monetary benefits by fair value, which may reduce carbon emissions.

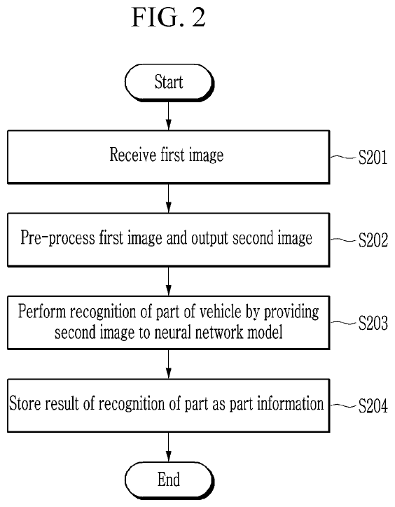

FIG. 2 shows an example of a vehicle part identifying method according to an example.

Referring to FIG. 2, a vehicle part identifying method according to an example may include: receiving a first image as input (S201); pre-processing the first image to output a second image (S202); performing recognition of a part of a vehicle by providing the second image to a neural network model that performs encoding to extract features from the input image and decoding to output a result of recognition of the part of the vehicle from the input image by using the extracted features (S203); and storing the result of the recognition of the part of the vehicle as part information (S204).

More specific details of the vehicle part identifying method may be applied with reference to the descriptions of the examples described herein, so that duplicative descriptions are omitted herein.

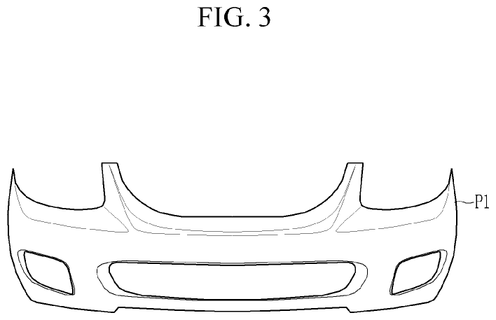

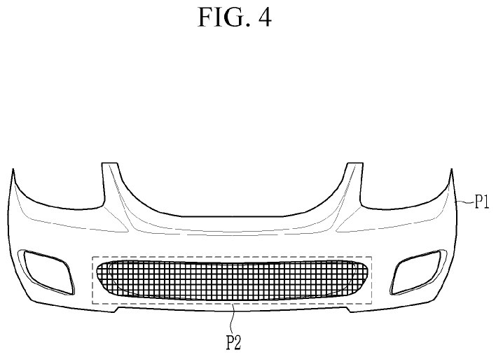

FIGS. 3 and 4 show examples of an operation of the vehicle part identifying device according to the example.

Referring to FIGS. 3 and 4, the part recognition module 13 of the vehicle part identifying device according to the example may recognize a front bumper P1 without a grille P2 and a front bumper P1 with a grille P2 differently. For example, with respect to FIG. 3, the part recognition module 13 may obtain that the number of parts in the input image is one, and obtain that the one part is the front bumper P1. In contrast, with respect to FIG. 4, the part recognition module 13 may obtain that the number of parts in the input image is two, and obtain that the two parts are the front bumper P1 and the grille P2. This prevents the front bumper P1 without the grille P2 and the front bumper P1 with the grille P2 from being priced in the same unit and trading at the same price.

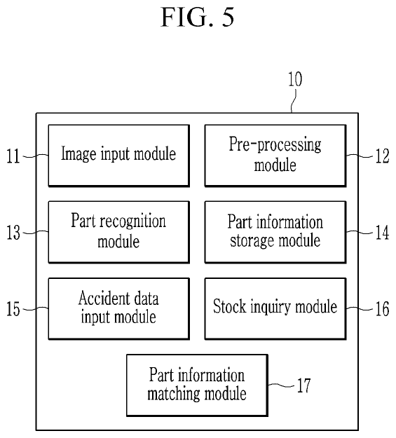

FIG. 5 shows an example of a vehicle part identifying device according to an example.

Referring to FIG. 5, a vehicle part identifying device 10 according to the example may include an image input module 11, a pre-processing module 12, a part recognition module 13, a part information storage module 14, an accident data input module 15, a stock inquiry module 16, and a part information matching module 17. Since reference can be made herein to the foregoing description of the image input module 11, the pre-processing module 12, the part recognition module 13, and the part information storage module 14 with respect to FIG. 1, the accident data input module 15, the stock inquiry module 16, and the part information matching module 17 will be described herein.

The accident data input module 15 may receive input of accident data representing the occurrence of an accident. Specifically, if the vehicle is involved in an accident, the accident data input module 15 may receive accident data from an accident maintenance data provider that includes information about which parts were damaged in the accident and need to be replaced.

The stock inquiry module 16 may inquire the real-time stock of needed parts based on the accident data. Specifically, the stock inquiry module 16 may first access a database of the vehicle's parts supplier to inquire the real-time stock of the parts needed to repair the vehicle and, if available, obtain pricing information for the corresponding part.

The part information matching module 17 may match part information matched to a required part in the part information storage module 14 and provide the matched part information to the user. Specifically, if the part is to be used for repairing the vehicle is out of stock according to the real-time stock inquiry of the stock inquiry module 16, the part information matching module 17 may match part information matching the required part in the part information storage module 14 and provide the matched part information to the user. Otherwise, despite the fact that the part required for repairing the vehicle is in stock according to the real-time stock inquiry of the stock inquiry module 16, the part information matching module 17 may match part information matching the required part in the part information storage module 14 and provide the matched part information to the user. As a result, the user may compare the price information of the part according to the real-time stock inquiry and the price information of the matched used part and select the desired part.

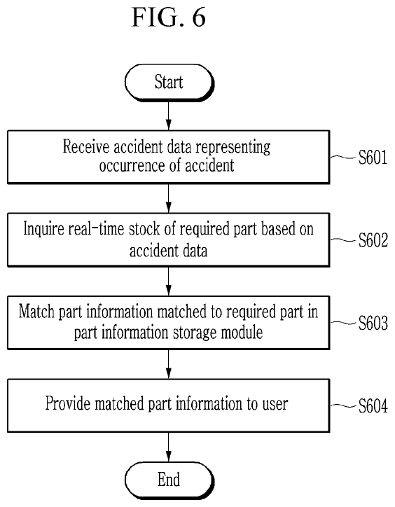

FIG. 6 shows an example of a vehicle part identifying method according to an example.

Referring to FIG. 6, a vehicle part identifying method according to an example may include: receiving accident data representing an accident occurrence (S601); inquiring a real-time stock of a required part based on the accident data (S602); matching part information matching the required part in a part information storage module (S603); and providing the matched part information to a user (S604).

More specific details of the vehicle part identifying method may be applied with reference to the descriptions of the examples described herein, so that duplicative descriptions are omitted herein.

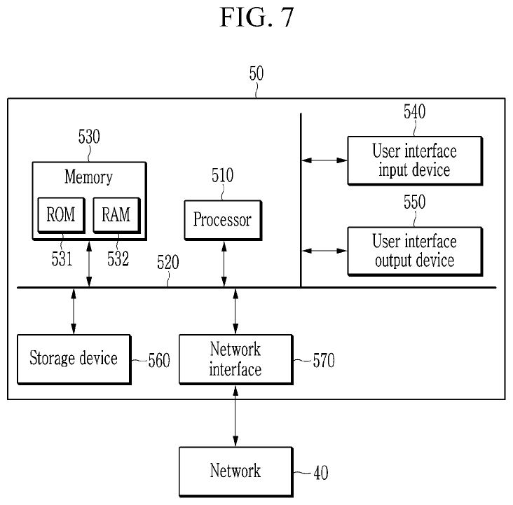

FIG. 7 shows an example of a computing device according to an example.

Referring now to FIG. 7, the vehicle part identifying device and method according to the examples may be implemented by using a computing device 50.

The computing device 50 may include at least one of a processor 510, a memory 530, a user interface input device 540, a user interface output device 550, and a storage device 560 communicating through a bus 520. The computing device 50 may also include a network interface 570 that electrically connects to the network 40. The network interface 570 may transmit or receive a signal with another entity through the network 40.

The processor 510 may be implemented in various types, such as a an Application Processor (AP), a Central Processing Unit (CPU), a Graphic Processing Unit (GPU), and the like, and may be a predetermined semiconductor device executing commands stored in the memory 530 or the storage device 560. The processor 510 may be configured to implement the functions and the methods described above with reference to FIGS. 1 to 6.

The memory 530 and the storage device 560 may include various types of volatile or non-volatile storage media. For example, the memory may include a Read Only Memory (ROM) 531 and a Random Access Memory (RAM) 532. In the example, the memory 530 may be located inside or outside the processor 510, and the memory 530 may be connected with the processor 510 through already known various means.

The present disclosure attempts to provide a device and method for identifying parts of a vehicle which are capable of performing objective and automated part identification through image analysis for use in used parts related services. The present disclosure may solve the existing problems in that manual visual identification by humans results in different part names, categories, and the like for different people and a part is priced based on inaccurate part unit, so that it is possible to implement fast and accurate part identification in an automated method through image analysis, and also price an accurate part unit, which contributes to the revitalization of the used parts trade and reduces carbon emissions.

An example of the present disclosure provides a device for identifying a part of a vehicle, the device including: an image input module for receiving a first image; a pre-processing module for pre-processing said first image to output a second image; a part recognition module for performing recognition of a part of a vehicle by providing said second image to a neural network model that encodes to extract features from said input image, and decodes to output a result of recognition of the part of the vehicle from said input image by using said features; and a part information storage module for storing the result of the recognition of the part as part information.

In several examples, the pre-processing module may recognize a position of a part in the first image, and crop the first image to include an entirety of the part based on the position of the part.

In several examples, the pre-processing module may crop the first image to a ratio of 4:3.

In several examples, the pre-processing module may change a pixel value of the first image to a first value or a second value.

In several examples, the pre-processing module may change a channel of the first image to three channels or one channel.

In several examples, the pre-processing module may change an array of the first image according to a form of input supported by the neural network model.

In several examples, the part recognition module may obtain the number of parts in the second image by using the above neural network model, and obtain the types of parts by the number of parts.

In several examples, the part recognition module may additionally or alternatively obtain at least one of a compatible vehicle model of the part and a color of the part.

In several examples, the neural network model may include a U-net model.

In several examples, the device may further include: an accident data input module for receiving accident data representing occurrence of an accident as input; a stock inquiry module for, based on the accident data, inquiring a real-time stock of a required part; and a part information matching module for matching part information matched to the required part in the above part information storage module and providing the matched part information to a user.

Another example of the present disclosure provides a method of identifying a part of a vehicle, the method may include: receiving a first image; pre-processing the first image to output a second image; performing recognition of a part of a vehicle by providing the second image to a neural network model that encodes to extract features from the input image, and decodes to output a result of recognition of the part of the vehicle from the input image by using the features; and storing the result of the recognition of the part as part information.

In several examples, the pre-processing of the first image to output the second image may include: recognizing a position of a part in the first image; and cropping the first image to include an entirety of the part based on the position of the part.

In several examples, the pre-processing of the first image to output the second image may include cropping the first image to a ratio of 4:3.

In several examples, the pre-processing of the first image to output the second image may include changing a pixel value of the first image to a first value or a second value.

In several examples, the pre-processing of the first image to output the second image may include changing a channel of the first image to three channels or one channel.

In several examples, the pre-processing of the first image to output the second image may include changing an array of the first image according to a form of input supported by the neural network model.

In several examples, the performing of the recognition of the part of the vehicle may include: obtaining the number of parts in the second image by using the above neural network model; and obtaining the types of the parts by the number of the parts.

In several examples, the performing of the recognition of the part of the vehicle may include additionally or alternatively obtaining at least one of a compatible vehicle model of the part and a color of the part.

In several examples, the neural network model may include a U-net model.

In several examples, the method may further include: receiving accident data representing occurrence of an accident as input; based on the accident data, inquiring a real-time stock of a required part; and matching part information matched to the required part in the above part information storage module and providing the matched part information to a user.

According to the examples described above, accurate part identification may be achieved through image analysis, thereby providing objective and automated part identification for use in used part-related services.

In several examples, at least some configurations or functions of the vehicle part identifying device and method according to the examples may be implemented as programs, instructions, or software executed on the computing device 50, and the programs or software may be stored on a computer-readable medium.

In several examples, at least some configurations or functions of the vehicle part identifying device and method according to the examples may be implemented using hardware or circuit of the computing device 50, or may be implemented as separate hardware or circuit that may be electrically connected to computing device 50.

According to the examples described above, accurate part identification may be achieved through image analysis, thereby providing objective and automated part identification for use in used part-related services. Accordingly, it is possible to reduce the risk of exchanges and returns due to mislabeled parts, ensure that used parts are properly priced according to their value, and reduce scrap disposal costs. In addition, the supply of used parts to the market may be further stimulated by used parts companies receiving monetary benefits by fair value, which may reduce carbon emissions.

Although the above examples of the present disclosure have been described in detail, the scope of the present disclosure is not limited thereto, but also includes various modifications and improvements by one of ordinary skill in the art utilizing the basic concepts of the present disclosure as defined in the following claims.

What is claimed is:

1. A device comprising:
a processor;
memory storing instructions, when executed by the processor, cause the device to:
receive a first image;
pre-process the first image to output a second image;
provide the second image to a neural network model that extracts features from the second image, and outputs, based on the extracted features, information associated with a recognized part of a vehicle;
store the information associated with the recognized part of the vehicle as vehicle part information; and
cause, based on the vehicle part information, a delivery of the recognized part of the vehicle.

2. The device of claim 1, wherein the instructions, when executed by the processor, cause the device to:
recognize a position of the recognized part in the first image, and
crop, based on the position of the recognized part, the first image to include an entirety of the recognized part.

3. The device of claim 2, wherein the instructions, when executed by the processor, cause the device to:
crop by adjusting dimensions of the first image so that a ration of a width of the first image to a height of the first image is of 4 to 3.

4. The device of claim 2, wherein the instructions, when executed by the processor, cause the device to:
change a pixel value of the first image to a new value.

5. The device of claim 2, wherein the instructions, when executed by the processor, cause the device to:
change the first image to have three color channels or one color channel.

6. The device of claim 2, wherein the instructions, when executed by the processor, cause the device to:
change an array of the first image based on a form of input associated with the neural network model.

7. The device of claim 1, wherein the instructions, when executed by the processor, cause the device to:
determine, based on the neural network model, a number of vehicle parts in the second image; and
determine, based on the number of vehicle parts, types of the vehicle parts.

8. The device of claim 7, wherein the instructions, when executed by the processor, cause the device to:
determine at least one of a compatible vehicle model of the recognized part or a color of the recognized part.

9. The device of claim 1, wherein:
the neural network model comprises a U-net model.

10. The device of claim 1, wherein the instructions, when executed by the processor, cause the device to:
receive accident data associated with an occurrence of an accident as an input to the neural network model;
based on the accident data, accessing the vehicle part information to search for a vehicle part associated with the accident data; and
providing information associated with the vehicle part from the vehicle part information to a user.

11. A method comprising:
receiving, by a processor, a first image;
pre-processing the first image to output a second image;
providing the second image to a neural network model that extracts features from the second image, and outputs, based on the extracted features, information associated with a recognized part of a vehicle;
storing the information associated with the recognized part of the vehicle as vehicle part information; and
causing, based on the vehicle part information, a delivery of the recognized part of the vehicle.

12. The method of claim 11, wherein the pre-processing comprises:
recognizing a position of the recognized part in the first image; and
cropping, based on the position of the recognized part, the first image to include an entirety of the recognized part.

13. The method of claim 12, wherein the pre-processing comprises:
cropping by adjusting dimensions of the first image so that a ration of a width of the first image to a height of the first image are in is 4 to 3.

14. The method of claim 12, wherein the pre-processing comprises:
changing a pixel value of the first image to a new value.

15. The method of claim 12, wherein the pre-processing comprises:
changing the first image to have three color channels or one color channel.

16. The method of claim 12, wherein the pre-processing comprises:
changing an array of the first image based on a form of input associated with the neural network model.

17. The method of claim 11, wherein the providing comprises:
determining, based on the neural network model, a number of vehicle parts in the second image; and
determining, based on the number of vehicle parts, types of the vehicle parts.

18. The method of claim 17, wherein the providing comprises:
determining at least one of a compatible vehicle model of the recognized part or a color of the recognized part.

19. The method of claim 11, wherein the neural network model comprises a U-net model.

20. The method of claim 11, further comprising:
receiving accident data associated with an occurrence of an accident as an input to the neural network model;
based on the accident data, accessing the vehicle part information to search for a vehicle part associated with the accident data; and
providing information associated with the vehicle part from the vehicle part information to a user.
